(19) United States
(12) Patent Application Publication
(10) Pub. No.: US 2021/0204471 A1
(43) Pub. Date: Jul. 8, 2021

(54) PLANT CHARACTERIZATION

(71) Applicant: Land O'Lakes, Inc., Arden Hills, MN (US)

(72) Inventors: John Kinnard, Arden Hills, MN (US); Steve Anthofer, Carroll, IA (US)

(21) Appl. No.: 16/736,572

(22) Filed: Jan. 7, 2020

(51) Int. Cl. A01C 14/00; A01C 21/00

(52) U.S. Cl. CPC A01C 14/00; A01C 21/005

(57) ABSTRACT

Methods of characterizing distinct plant varieties involve planting the plant varieties in one or more field plots. Each field plot includes one or more crop rotation zones, one or more maturity zones within the rotation zones, one or more nitrogen exposure zones within the maturity zones, and one or more population zones. Methods further involve extracting growth data from the plant varieties after a growing period. Systems for characterizing distinct plant varieties include one or more field plots and a database configured to store growth data extracted from the plant varieties after a growing period.

### TECHNICAL FIELD

Implementations relate to plant growth characterization using specialized field plots and associated techniques. Particular implementations involve the characterization of hybrid corn varieties in different growing conditions using modular field plots.

### BACKGROUND

Vast expansion in the diversity of genetically distinct field crops has provided growers with a large selection of plant seeds to choose from. Selecting the varieties most suitable for a particular set of growing conditions can be difficult, a decision often hampered by the lack of data specific to the growing conditions faced by a particular grower. The effectiveness of fertilizers, fungicides and/or pesticides may also vary with respect to different hybrid varieties, resulting in widespread waste of such additives. Accordingly, many variables impact plant growth, and identifying which plants, of many, will succeed in a particular location, remains elusive.

### BRIEF DESCRIPTION OF THE DRAWINGS

FIG. 1 is a diagram of a field plot designed in accordance with principles of the present disclosure.

FIG. 2 is a more detailed view of a portion of the field plot shown in FIG. 1.

FIG. 3 is a diagram of a plant characterization and presentation system configured in accordance with principles of the present disclosure.

FIG. 4 is a flow diagram of a method performed in accordance with principles of the present disclosure.

### SUMMARY

Implementations provide modular field plots and associated techniques configured to systematically evaluate a large assortment of plant varieties subjected to a wide range of growing conditions. Embodiments include customizable field plots and high-throughput methods for characterizing plant hybrids in different growing conditions. Such conditions can encompass environmental factors, including temperature, soil type, and/or precipitation, for example, and also agricultural factors, including levels of applied nitrogen, plant population density, fungicide application, and/or crop rotation schemes, just to name a few. The field plots can be grown and evaluated in multiple geographic locations to uncover regional differences in crop production responsive to each of the variables tested. Disclosed plant characterization processes are thus designed to distinguish genetic hybrid varieties with respect to a wide range of practical factors frequently confronted by growers looking to improve efficiency and optimize yield.

In accordance with principles of the present disclosure, a method of characterizing distinct plant varieties can involve planting the plant varieties in one or more field plots. Each field plot may include one or more crop rotation zones, one or more maturity zones within the rotation zones, one or more nitrogen exposure zones within the maturity zones, and one or more population zones within the maturity zones. The method can further involve extracting growth data from the plant varieties after a growing period.

In some examples, the crop rotation zones comprise a continuous planting zone within which a single plant species is planted in consecutive growing seasons. In some embodiments, the crop rotation zones comprise a rotating zone within which a single plant species is not planted in consecutive growing seasons. In some examples, the maturity zones each include plants having a distinct age-to-maturity ranging from 80 to 120 days. In some embodiments, the nitrogen exposure zones include at least one high nitrogen zone and/or at least one low nitrogen zone. In some examples, the population zones include at least one high population zone and/or at least one low population zone. In some embodiments, the high population zone includes about 35,000 to about 40,000 plants per acre and the low population zone includes about 20,000 to about 30,000 plants per acre. In some embodiments, each field plot includes 9 maturity zones, each maturity zone comprising 2 subplots, each subplot comprising a nitrogen exposure zone and a population zone. In some examples, each subplot includes about 15 to about 30 distinct plant varieties, inclusive. In some embodiments, each plant variety comprises a hybrid of a same species. In some such examples, the same species comprises corn. In some examples, each of the distinct plant varieties is planted in replicate within each subplot. In some embodiments, the field plots are duplicated in two or more distinct geographical locations. In some examples, the growth data comprises average yield data.

In accordance with principles of the present disclosure, a system for characterizing distinct plant varieties includes one or more field plots. Each field plot may include one or more crop rotation zones, one or more maturity zones within the rotation zones, one or more nitrogen exposure zones within the maturity zones, and one or more population zones within the maturity zones. The system can further include a database configured to store growth data extracted from the plant varieties after a growing period.

In some examples, the crop rotation zones comprise a continuous planting zone within which a single plant species is planted in consecutive growing seasons and a rotating zone within which a single plant species is not planted in consecutive growing seasons. In some embodiments, the maturity zones each include plants having a distinct age-to-maturity ranging from 80 to 120 days. In some examples, the nitrogen exposure zones include at least one high nitrogen zone and/or at least one low nitrogen zone. In some embodiments, the population zones include at least one high population zone comprising about 35,000 to about 40,000 plants per acre and at least one low population zone comprising about 20,000 to about 30,000 plants per acre. In some examples, each field plot includes 9 maturity zones, each maturity zone comprising 2 subplots, each subplot comprising a nitrogen exposure zone and a population zone.

### DETAILED DESCRIPTION

Each of the field plots disclosed herein comprise a unitary tract of arable land used in agricultural operations at a particular geographic location. Each field plot includes an adjustable, modular design configured to evaluate a variety of plant hybrids under different growing conditions. The field plots and associated methods can be employed to evaluate the performance of an assortment of plants and determine the impact of different agronomic practices on crop production. As a result, optimized placement of certain plant types can be determined and communicated to growers. Each field plot can be utilized to evaluate a plurality of variables, including crop rotation scheme, fertility treatment, plant population, irrigation, soil type and/or temperature with respect to a plurality of plant hybrids. The field plots and associated methods can be replicated in multiple geographic locations to expand the volume and scope of information derived therefrom. Embodiments can also involve systems configured to store, process and display such information in accordance with user instructions.

As used herein, the term “hybrid” may refer to plants created by crossing two genetically distinct parent plants. Methods of creating the hybrids, e.g., cross-pollination, may vary. While example methods described herein refer to the assessment of different corn varieties, it should be understood that reference to corn is for ease of illustration, only, and other plant species may also be evaluated according to principles of the present disclosure. For example, soybeans, alfalfa, barley, rice, and/or wheat varieties, among others, can also be evaluated.

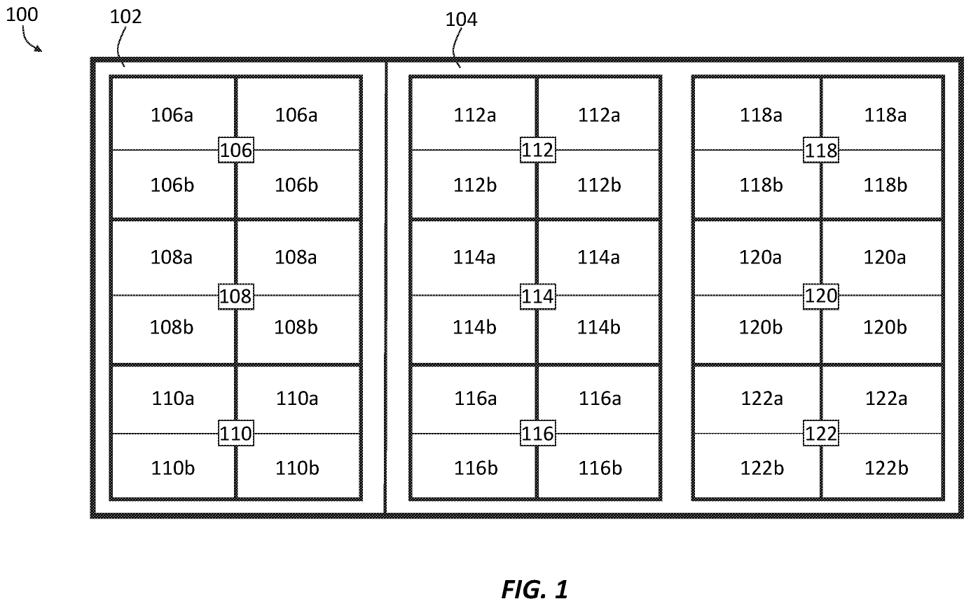

FIG. 1 shows an example field plot 100 in accordance with principles of the present disclosure. As shown, the field plot 100 can include one or more defined zones therein, each zone comprising a discrete portion of the field plot 100 separate, but adjacent to, other zones within the plot. The field plot 100 shown in this embodiment includes two crop rotation zones 102, 104. The first crop rotation zone 102 defines an area where different plant species, e.g., corn and soybeans, are alternated in consecutive growing seasons, such that either corn or soybeans are not planted in zone 102 in consecutive growing seasons. The first crop rotation zone 102 may thus be referred to as the “rotation zone,” “rotating zone” or “first-year corn zone.” The second crop rotation zone 104 defines an area where a single plant species, e.g., corn, is planted in consecutive growing seasons, such that no soybeans or other crops are interleaved. The second crop rotation zone may thus be referred to as the “continuous plant zone” or the “continuous corn zone.” In additional examples, other plants instead of or in addition to corn or soybeans may be included in crop rotation zone 102 and/or 104. By including a first-year corn zone 102 and a continuous corn zone 104, in select embodiments, the field plot 100 may be utilized to determine which genetic varieties of corn are most impacted by the rotational effects caused by a specific plant type. For example, some varieties of corn may thrive in the continuous corn zone, while others may only succeed when preceded by soybeans, or some other plant that is different from corn.

The configuration of the first crop rotation zone 102 and second crop rotation zone 104 may vary. For example, the relative size of the zones may be switched, such that the first crop rotation zone 102 is smaller than the second crop rotation zone 104. In some embodiments, the first crop rotation zone 102 or second crop rotation zone 104 may be omitted, such that the entire field plot 100 includes only one crop rotation scheme.

Within the crop rotation zones 102, 104, the field plot 100 can include a plurality of maturity sets 106-122. Each maturity set defines an area of distinct age-to-maturity for the plants included therein. For corn, the age-to-maturity may be defined by the number of days between planting and physiological maturity, which may be defined as the age at which the kernel black layer forms at the tip of the kernels. The total age-to-maturity of each set may vary, ranging from about 60, 65, 70, 75, 80, 85, 90, 95, 100, 105, 110, 115, 120, 125, 130, 135, 140, 145 or 150 days or more, or any length of time therebetween, for example a range of about 80 to about 120 days, specifically. The intervals between consecutive maturity sets, defined as the difference in maturity age between two plant varieties, included in a particular field plot may also vary, ranging from about 1 to about 20 days, about 2 to about 15 days, about 3 to about 10 days, about 4 to about 8 days, or about 5 days in various examples. The number of distinct maturity sets, each set defined by a unique age-to-maturity, included in a single trial can also vary, ranging from 1 to about 20 or more, about 2 to about 18, about 4 to about 16, about 6 to about 14, about 8 to about 12, or about 9. In the embodiment shown, maturity sets 106, 112 and 118 each define maturity ages of 110 days. Maturity sets 108, 114 and 120 each define maturity ages of 105 days. Maturity sets 110, 116 and 122 each define maturity ages of 100 days.

As further shown in FIG. 1, each maturity set may be further compartmentalized into subplots defined by various growing conditions. The growing conditions can include environmental and artificial variables. For example, the growing conditions within each subplot may vary with respect to nitrogen exposure, e.g., ranging from non-limiting nitrogen to zero nitrogen. Plants exposed to non-limiting nitrogen, which may be referred to as “non-limited nitrogen” herein, may not be nitrogen-deficient at any point during a given growing season. Ensuring non-limiting nitrogen exposure can involve repeated nitrogen applications throughout a growing season. By exposing other plants to low or even zero nitrogen levels, the plants may mimic plants grown in high-stress regions, where nutrients may be depleted or scarce.

The subplots may also vary with respect to plant population, ranging from high population to low population. Populations may be based on stress and/or yield levels. For example, geographic locations that typically experience lower levels of stress, e.g., rarely experiencing drought and/or excessive heat, may include high-population subplots planted with, for example, about 30,000 to about 40,000 plants per acre, or any value therebetween. By contrast, geographic locations that typically experience higher levels of stress in the form of drought and/or excessive heat, may include low-population subplots planted with, for example, about 20,000 to about 30,000 plants per acre, or any value therebetween. In the example shown, high population subplots include 38,000 plants per acre, and low population subplots include 30,000 plants per acre.

The particular arrangement of different growing conditions and/or maturity sets may vary in different examples. In the specific example shown, subplots 106a, 108a, 110a, 112a, 114a and 116a comprise high population, high nitrogen subplots. Subplots 106b, 108b, 110b, 112b, 114b and 116b comprise low population, high nitrogen subplots. Subplots 118a, 120a and 122a comprise high population, low nitrogen subplots, and subplots 118b, 120b and 122b comprise low population, low nitrogen subplots. Accordingly, the field plot 100 shown in FIG. 1 is configured to grow a plurality of corn plants under the following 6 management schemes: (1) continuous corn, low nitrogen, high population; (2) continuous corn, low nitrogen, low population; (3) continuous corn, high nitrogen, high population; (4) continuous corn, high nitrogen, low population; (5) first-year corn; high nitrogen, high population; and (6) first-year corn, high nitrogen, low population.

Management schemes can be adjusted each growing season by modifying the conditions applied within each subplot. In some examples, growers utilizing the field plot 100 may specify a customized management scheme for application to one or more user-selected hybrids. Users may also specify one or more hybrids to be tested in one or more growing seasons under one or more of the 6 management schemes represented in FIG. 1. The management schemes can be utilized to evaluate different plant varieties in different geographical regions, thereby further assessing the performance of such plants in different environments, with variable temperature, humidity, precipitation, sunlight, etc.

In some embodiments, additional management schemes may be implemented by adding one or more maturity sets containing one or more subplots defined by at least one different growing condition. For example, growing conditions may include fungicide exposure, ranging from high fungicide to low fungicide. Additional growing conditions can include herbicide and/or pesticide exposure, irrigation level, and/or sunlight exposure.

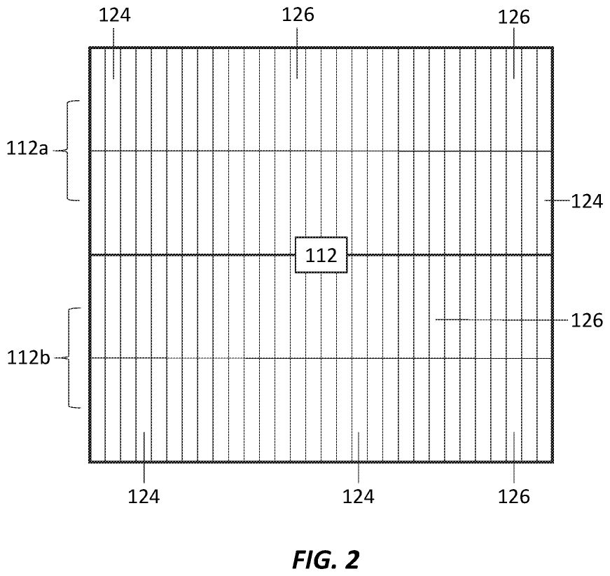

Each subplot defined by distinct growing conditions within the field plot 100 can include hybrid replicates to improve the statistical significance of the data gleaned from the field plot. For example, maturity set 106 includes a first pair of subplots 106a and a second pair of subplots 106b. This represents two identical sets of hybrid plant varieties within each management scheme. The arrangement of hybrid replicates shown in FIG. 1 is for illustration purposes only. As further shown in FIG. 2, for example, the hybrid replicates may be intermingled within each subplot to reduce the impact of localized variation in soil composition, for instance, on plant growth, although the soil composition within each field plot may be substantially uniform to ensure consistent results within the area defined by each plot.

FIG. 2 shows a close-up view of maturity set 112, including subplots 112a and 112b. In the example shown, each subplot 112a and 112b includes 30 genetically distinct hybrid plant varieties planted in replicate, i.e., in 2 separate sections. Accordingly each subplot 112a, 112b is divided into 60 distinct sections, each of which may include a single hybrid variety. The number of plants and/or their arrangement within each section may vary. In some examples, each hybrid section can include 1, 2, 3, 4, 5, or 6 rows or more, each row having a length of about 20, 25, 27.5, 30, 35, or 40 feet or more. By including hybrid replicates within each subplot 112a, 112b, phenotypic data from each hybrid section can be averaged or at least compared to its replicate hybrid section, thereby improving the statistical integrity of the data. The manner in which individual hybrid varieties are organized within each subplot 112a, 112b may vary. For example, hybrids may be randomized within each subplot, or hybrids constituting a given replicate pair may be arranged at opposite ends of each subplot, to the extent possible. In various embodiments, hybrid replicates may be organized such that no hybrid is positioned adjacent to its replicate, or within 2, 3, 4, 5, 6, 7, 8, 9, or 10 rows from its replicate. In the example shown, 2 hybrid sections are labeled for illustration purposes, only. The first hybrid 124 includes 2 sections planted at separate ends of separate rows within subplot 112a, and within the same row, but not adjacent to each other, within subplot 112b. The second hybrid 126 includes 2 sections planted in the same row, but not adjacent to each other, within subplot 112a, and within separate rows of subplot 112b. The remainder of distinct sections shown in FIG. 2 may include additional hybrid varieties, distinct from hybrids 124 and 126, intermingled in a similar manner.

The number of distinct hybrid varieties included in each maturity set may vary. The maturity set 112 includes 30 distinct hybrids, while other maturity sets may contain fewer, e.g., 15 hybrids, or more, e.g., 45, hybrids. For example, maturity sets defining ages-to-maturity of 80 and/or 120 days may each include 15 distinct hybrids, while all other maturity sets may contain 30 distinct hybrids. According to such embodiments, a single field plot, such as field plot 100, can evaluate up to about 240 distinct hybrids.

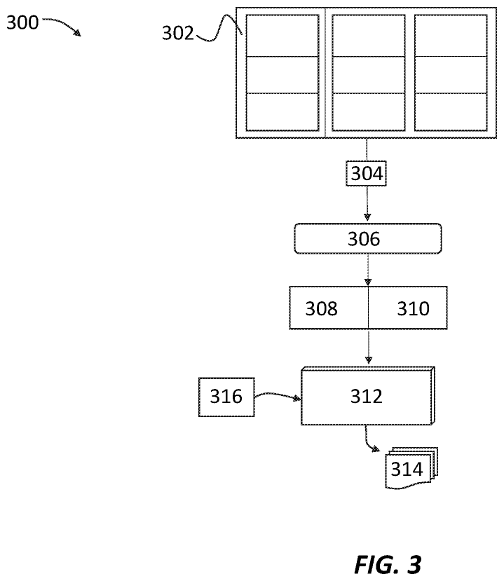

FIG. 3 shows a plant characterization and presentation system 300 implemented in accordance with principles of the present disclosure. The system 300 includes a field plot 302, which as described herein, can include a variety of crop rotation zones and maturity sets, each maturity set including a variety of growing conditions and distinct hybrid varieties. From the field plot 302, plant growth data 304 can be gleaned at various time points throughout the plant lifecycle. For example, growth data 304 may be observed at the age-to-maturity, just before harvest, between planting and age-to-maturity, or any point therebetween. The data 304 can be input to a database 306, either remotely from the field plot 302, or at a data center separate from the field plot. In some examples, the data 304 can be analyzed by a data processor 308, which may be programmed to perform one or more operations specified by a user. The data processor 308 may be communicatively coupled with a display processor 310 configured to organize the data according to one or more user specifications. After processing, the data 304 can be transmitted to a user interface 312 communicatively coupled with the data and/or display processors 308, 310. The user interface 312, in conjunction with the display processor 310, can display a customized set of data 314 to a user for further analysis. The customized data 314 may include plant performance data specific to one or more hybrid varieties, growing conditions, maturity sets, and/or geographical locations. Such details may be specified in user input 316 received at the user interface 312. The user interface 312 may include various stationary or mobile computer devices, e.g., desktop computers, cell phones, tablets, etc., configured to readily receive and display the customized data 314 in accordance with user preferences. One or more components of the system 300 can be omitted in some embodiments. For example, the system 300 may include the field plot 302 and the database 304, only, while one or more additional components, such as the user interface 312, may be omitted.

In embodiments, the growth data 304 may be gathered from multiple field plots 302, including field plots located at different geographic sites. For example, the growth data 304 may be local, regional, national or international. Local growth data may reflect a small number of field plots, e.g., 1, 2, or 3 field plots, clustered in the same, or nearly the same, location. Regional growth data may encompass growth data averaged between sites spread across southern, western, west central, east central, eastern, and/or northern regions of the United States, for example. Regional growth data may also encompass data gathered from field plots located in individual states. National growth data can include data averaged from two or more distinct regions or data averaged from all sites including at least one field plot within the United States. An end user may specify the geographic scope of data collected for a particular plant variety, thereby enabling the user to view local, regional, national and/or international averages for a particular trait, e.g., yield, for a particular plant variety.

In addition or alternatively, the growth data 304 can be stratified according to soil texture. For example, distinct soil textures may include coarse, medium and fine. Coarse soil may include sand, loamy sand and/or sandy loam. Medium soil may include loam, silt loam and/or silt. Fine soil may include sandy clay loam, silty clay loam, clay loam, sandy clay, silty clay and/or clay. Within each soil texture, the growth data 304 can be further categorized based on irrigation scheme.

After all growth data 304 is collected, field plots may be grouped according to overall averages for each field plot location. In some examples, the growth data 304 may be grouped according to average yield. For instance, the growth data 304 may be used to identify low yield environments (less than about 130 bushels/acre), moderate yield environments (about 130-180 bushels/acre), and high yield environments (greater than 180 bushels/acre). Cutoffs for the various yield environments can be adjusted based on the distribution of yield averages. Accordingly, low yield environments may include average yields of about 110 to about 150 bushels/acre, moderate yield environments may include average yields of about 120 to about 200 bushels/acre, and high yield environments may include average yields of about 160 to about 220 bushels/acre. Growth data 304 may additionally or alternatively include data regarding plant height, kernel number, leaf size, ear prolificacy, etc.

Due to the different management schemes evaluated within each field plot, the growth data 304 can also be utilized to determine each plant variety's response to one or more growing conditions. The average yield data for subplots subjected to the same condition with respect to a variable can be subtracted from the average yield data for the subplots subjected to the opposite condition with respect to the same variable. For example, within a given field plot, each corn hybrid's response to nitrogen may be determined by adding the average yield data from the continuous corn, high nitrogen, high population management scheme and the continuous corn, high nitrogen, low population management scheme. From this sum, the average yield data from the continuous corn, low nitrogen, high population management scheme and the continuous corn, low nitrogen, low population management scheme may be subtracted. In this manner, plants exhibiting a strong increase in yield responsive to high nitrogen exposure can be distinguished from plants exhibiting a negligible or even negative response to high nitrogen exposure. Such data may be especially valuable for growers looking to fine tune fertilizer applications based on the hybrids' propensity to utilize those nitrogen inputs. Data indicative of one or more plants' response to nitrogen, crop rotation and/or population, for example, may be quantified in a “response-to score,” which may be higher for plants exhibiting a stronger response to a particular variable. The response-to score may be determined by the data processor 308 and communicated to an end user for display on the user interface 312.

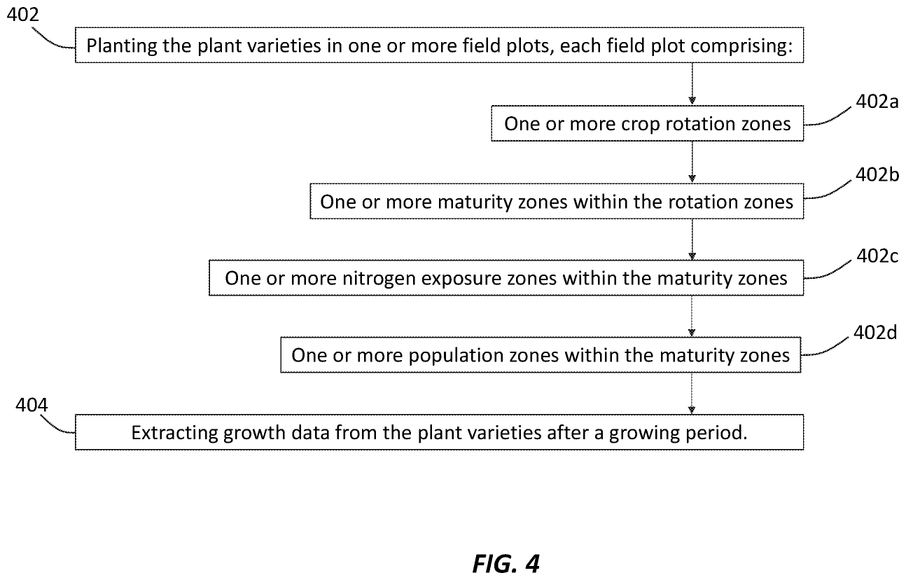

FIG. 4 is a flowchart of an example method 400 of characterizing plant varieties implemented in accordance with the present disclosure. The example method 400 shows the steps that may be implemented, in any sequence. In additional examples, one or more of the steps shown in the method 400 may be supplemented or omitted.

In the embodiment shown, the method 400 begins at block 402 by planting the plant varieties in one or more field plots. As shown at block 402a, the field plots may include one or more crop rotation zones. As shown at block 402b, the field plots may include one or more maturity zones within the rotation zones. As shown at block 402c, the field plots may include one or more nitrogen exposure zones within the maturity zones. As shown at block 402d, the field plots may include one or more population zones within the maturity zones. The method 400 may continue at block 404 by extracting growth data from the plant varieties after a growing period.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or components used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of characterizing distinct plant varieties, the method comprising:
planting the plant varieties in one or more field plots, each field plot comprising:
one or more crop rotation zones;
one or more maturity zones within the rotation zones;
one or more nitrogen exposure zones within the maturity zones; and
one or more population zones within the maturity zones; and
extracting growth data from the plant varieties after a growing period.

2. The method of claim 1, wherein the crop rotation zones comprise a continuous planting zone within which a single plant species is planted in consecutive growing seasons.

3. The method of claim 1, wherein the crop rotation zones comprise a rotating zone within which a single plant species is not planted in consecutive growing seasons.

4. The method of claim 1, wherein the maturity zones each include plants having a distinct age-to-maturity ranging from 80 to 120 days.

5. The method of claim 1, wherein the nitrogen exposure zones include at least one high nitrogen zone and/or at least one low nitrogen zone.

6. The method of claim 1, wherein the population zones include at least one high population zone and/or at least one low population zone.

7. The method of claim 6, wherein the high population zone includes about 35,000 to about 40,000 plants per acre and the low population zone includes about 20,000 to about 30,000 plants per acre.

8. The method of claim 1, wherein each field plot includes 9 maturity zones, each maturity zone comprising 2 subplots, each subplot comprising a nitrogen exposure zone and a population zone.

9. The method of claim 8, wherein each subplot includes about 15 to about 30 distinct plant varieties, inclusive.

10. The method of claim 9, wherein each plant variety comprises a hybrid of a same species.

11. The method of claim 10, wherein the same species comprises corn.

12. The method of claim 9, wherein each of the distinct plant varieties is planted in replicate within each subplot.

13. The method of claim 1, wherein the field plots are duplicated in two or more distinct geographical locations.

14. The method of claim 1, wherein the growth data comprises average yield data.

15. A system for characterizing distinct plant varieties, the system comprising:
one or more field plots, each field plot comprising:
one or more crop rotation zones;
one or more maturity zones within the rotation zones;
one or more nitrogen exposure zones within the maturity zones; and
one or more population zones within the maturity zones; and
a database configured to store growth data extracted from the plant varieties after a growing period.

16. The system of claim 15, wherein the crop rotation zones comprise a continuous planting zone within which a single plant species is planted in consecutive growing seasons and a rotating zone within which a single plant species is not planted in consecutive growing seasons.

17. The system of claim 15, wherein the maturity zones each include plants having a distinct age-to-maturity ranging from 80 to 120 days.

18. The system of claim 15, wherein the nitrogen exposure zones include at least one high nitrogen zone and/or at least one low nitrogen zone.

19. The system of claim 15, wherein the population zones include at least one high population zone comprising about 35,000 to about 40,000 plants per acre and at least one low population zone comprising about 20,000 to about 30,000 plants per acre.

20. The system of claim 15, wherein each field plot includes 9 maturity zones, each maturity zone comprising 2 subplots, each subplot comprising a nitrogen exposure zone and a population zone.
